(19) United States
(12) Patent Application Publication
(10) Pub. No.: US 2012/0200779 A1
(43) Pub. Date: Aug. 9, 2012

(54) TELEVISION SIGNAL RECEIVER WITH SIGNAL SWITCHING CAPABILITY

(75) Inventors: CHIUNG-CHI LIN, TAIPEI CITY (TW); CHING-YI LIN, TAIPEI CITY (TW)

(73) Assignee: FLYTECH TECHNOLOGY CO., LTD., TAIPEI CITY (TW)

(21) Appl. No.: 13/023,630

(22) Filed: Feb. 9, 2011

(51) Int. Cl. H04N 5/268

(52) U.S. Cl. 348/706; 348/E05.057

(57) ABSTRACT

The instant disclosure relates to a television signal receiver having signal switching capability between the High-Definition Multimedia Interface (HDMI) and the Digital Visual Interface (DVI) signal. In particular, a television signal receiver using a mechanical signal selection unit to switch between the HDMI and DVI connectors, for receiving matching input digital signal, is disclosed.

### BACKGROUND OF THE INVENTION

1. Field of the Invention

The instant disclosure relates to a television signal receiver; in particular, to a television signal receiver having a plurality of digital signal connectors and a mechanical signal selection unit.

2. Description of Related Art

In recent years, digital signal transmission connectors are mainly categorized into two groups, namely, the High-Definition Multimedia Interface (HDMI) and the Digital Visual Interface (DVI). The conventional TV signal receiver only has either an HDMI or DVI digital signal connector. Therefore, to connect a DVI source signal with a TV signal receiver having only an HDMI connector, an HDMI-DVI adapter is needed. Likewise, to connect an HDMI source signal with a TV signal receiver having only a DVI connector, a DVI-HDMI adapter is needed. In other words, to switch between the HDMI signal and the DVI source signal, the signal adapter must be switched out based on the data structure of the signals.

### SUMMARY OF THE INVENTION

The instant disclosure provides a TV signal receiver, which comprises a signal processing unit, an HDMI connector, a DVI connector, and a mechanical signal selection unit. The signal processing unit receives and processes the HDMI or DVI signal from an electronic device. The HDMI connector receives the HDMI signal transmitted from the signal processing unit. Likewise, the DVI connector receives the DVI signal transmitted from the signal processing unit. The HDMI signal includes a first video data and a first audio data, while the DVI signal includes a second video data.

The mechanical signal selection unit is coupled to the signal processing unit on one end, and to the HDMI connector and the DVI connector on the other end. The mechanical signal selection unit selectively transmits the HDMI signal to the HDMI connector, or the DVI signal to the DVI connector. The mechanical signal selection unit can be a manual switch, wherein the manual switch can be a flip switch, a push-button switch, or a turn knob switch.

For one embodiment, the signal processing unit can include a signal retrieval module, a graphics processing unit, and a signal output control unit. The signal retrieval module receives the HDMI or DVI signal. When the received signal is HDMI, the signal retrieval module would retrieve the first video data and the first audio data from the HDMI signal. Then, the first video data is exported to the graphics processing unit, and the first audio data is exported to the signal output control unit. Next, to be compatible with the display setting of the TV signal receiver, the first video data is reformatted by the graphics processing unit into a third video data and exported to the signal output control unit. The signal output control unit would export the received third video data and the first audio data accordingly.

In addition, for the instant embodiment, when the signal retrieval module receives the DVI signal, the signal retrieval module would retrieve the second video data from the DVI signal, and export the second video data to the graphics processing unit. Next, to be compatible with the display setting of the TV signal receiver, the second video data is reformatted by the graphics processing unit into a fourth video data and exported to the signal output control unit. Thereby, the signal output control unit can export the received fourth video data accordingly.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a block diagram for one embodiment of the instant disclosure.

FIG. 2 shows a block diagram of digital signal processing of the signal retrieval module of the instant disclosure.

### DETAILED DESCRIPTION OF THE PREFERRED EMBODIMENT

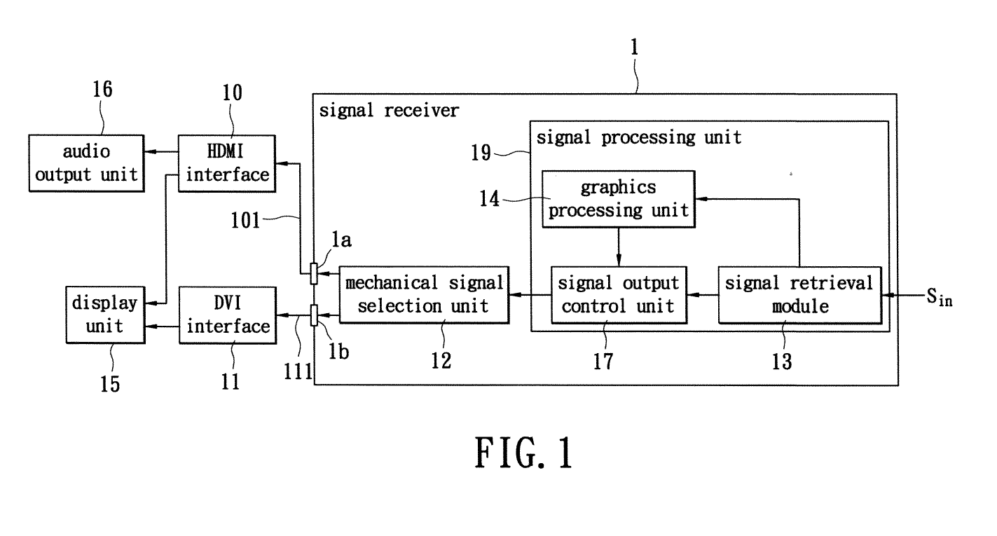

Please refer to FIG. 1, which shows a block diagram for one embodiment of the instant disclosure. As shown in FIG. 1, a TV signal receiver 1 comprises an HDMI connector 1a, a DVI connector 1b, a mechanical signal selection unit 12, and a signal processing unit 19. The signal processing unit 19 can further include a signal retrieval module 13, a graphics processing unit 14, and a signal output control unit 17. The TV signal receiver 1 receives an input signal Sᵢₙ transmitted from an electronic device. The input signal Sᵢₙ can be an HDMI or a DVI signal.

An HDMI interface 10 is connected to the TV signal receiver 1 through an HDMI cable 101. A DVI interface 11 is connected to the TV signal receiver 1 through a DVI cable 111. The HDMI connector 1a is used to receive the HDMI signal from the mechanical signal selection unit 12 and transmit to the HDMI interface 10. The HDMI interface 10 would export the received HDMI signal to an audio output unit 16 and a display unit 15, therefore allowing the display unit 15 and the audio output unit 16 to export visual graphics and sound respectively. The display unit 15 and the audio output unit 16 can be a television, a computer, a projector, or a DVD player, etc. The DVI connector 1b is used to receive the DVI signal from the mechanical signal selection unit 12 and transmit to the DVI interface 11. The DVI interface 11 would export the received DVI signal to the display unit 15 to show visual graphics.

The mechanical signal selection unit 12 can be a manual switch, such as a flip switch, a push-button switch, or a turn knob switch. The user can choose to export the HDMI signal to the HDMI connector la, or export the DVI signal to the DVI connector 1b. The flip type switch can be a dual in-line package (DIP) switch, etc. Based on the HDMI or DVI signal selected by the user, the mechanical signal selection unit 12 would transmit the signal to the HDMI connector 1a or the DVI connector 1b.

For example, if the mechanical signal selection unit 12 is pre-selected for the HDMI signal, and the received signal by the mechanical signal selection unit 12 is indeed an HDMI signal, the mechanical signal selection unit 12 would then transmit the HDMI signal to the HDMI connector 1a. Conversely, if the received signal by the mechanical signal selection unit 12 is a DVI signal instead, which does not match the HDMI selection of the mechanical signal selection unit 12, the mechanical signal selection unit 12 would not transmit the DVI signal to the HDMI connector 1a.

Likewise, if the mechanical signal selection unit 12 is pre-selected for the DVI signal, and the received signal by the mechanical signal selection unit 12 is indeed a DVI signal, the mechanical signal selection unit 12 would then transmit the DVI signal to the DVI connector 1b. Conversely, if the received signal by the mechanical signal selection unit 12 is an HDMI signal instead, which does not match the DVI selection of the mechanical signal selection unit 12; the mechanical signal selection unit 12 would not transmit the HDMI signal to the DVI connector 1b. Simply speaking, based on the pre-selected signal mode, the mechanical signal selection unit 12 can determine whether to transmit the received signal downstream to the HDMI interface 10 or DVI interface 11.

Please refer back to FIG. 1, where the signal retrieval module 13 of the signal processing unit 19 receives the input signal Sᵢₙ from the electronic device (such as a computer server). The input signal Sᵢₙ can be either an HDMI or a DVI signal. When the signal received by the signal retrieval module 13 is an HDMI signal, the signal retrieval module 13 would retrieve the first video data and the first audio data from the HDMI signal, and export the first video data to the graphics processing unit 14 and the first audio data to the signal output control unit 17. Next, to be compatible with the display setting of the TV signal receiver 1, the first video data is reformatted by the graphics processing unit 14 into a third video data and exported to the signal output control unit 17. Then, the signal output control unit 17 would export the received third video data and the first audio data simultaneously to the mechanical signal selection unit 12. Based on the signal mode selected by the user, the mechanical signal selection unit 12 would determine whether to transmit the first video data and the third audio data to the HDMI connector 1a.

On the other hand, when the received signal by the signal retrieval module 13 is a DVI signal, the signal retrieval module 13 would retrieve the second video data from the DVI signal, and export the second video data to the graphics processing unit 14. Next, to be compatible with the display setting of the TV signal receiver 1, the second video data is reformatted by the graphics processing unit 14 into a fourth video data and exported to the signal output control unit 17. Then, the signal output control unit 17 would export the received fourth video data to the mechanical signal selection unit 12. Based on the signal mode selected by the user, the mechanical signal selection unit 12 would determine whether to transmit the fourth video data to the DVI connector 1b.

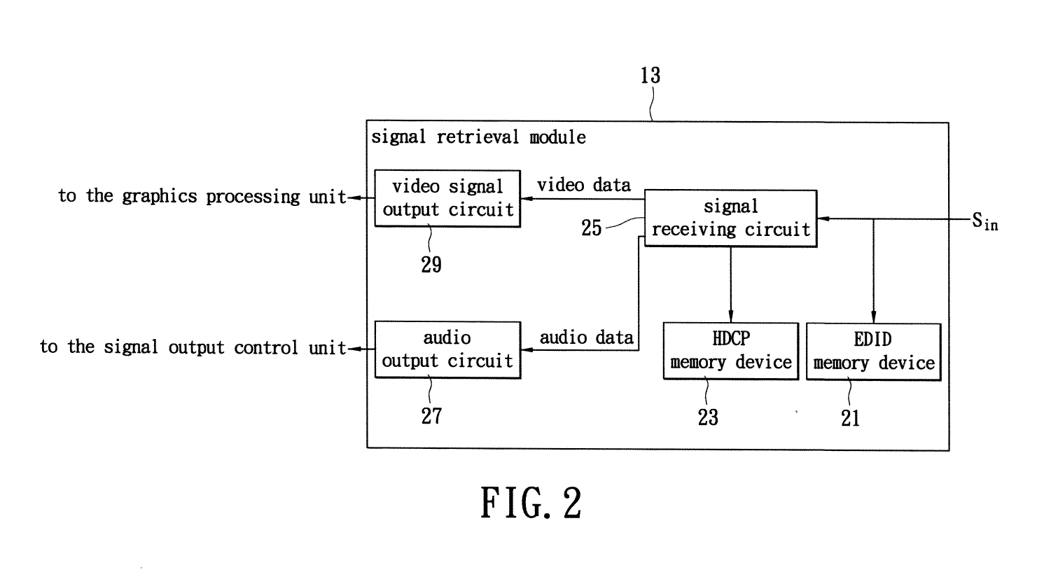

Please refer to FIG. 2, which shows a signal processing block diagram of the signal retrieval module 13. The signal retrieval module 13 comprises an EDID (Extended Display Identification Data) memory device 21, a HDCP (High-bandwidth Digital Content Protection) memory device 23, a signal receiving circuit 25, an audio output circuit 27, and a video signal output circuit 29.

The EDID memory device 21 stores the display resolution data, including the manufacture's name and serial number, for allowing the HDMI interface 10 or the DVI interface 11 to verify the resolution and pixel information of the display unit 15. The HDCP memory device 23 stores the copyright protection data, to prevent illegal copying of digital audio and video content, as the content travels across the DVI connector 1b or HDMI connector 1a.

The signal receiving circuit 25 receives the input signal Sᵢₙ from the electronic device (such as a computer sever), retrieves the video data, and transmits the retrieved video data to the video signal output circuit 29, for exporting the video data to the graphics processing unit 14 by the video signal output circuit 29. Next, the video data is processed by the graphics processing unit 14, which reformats the video data according to the display setting of the TV signal receiver 1, and exports the reformatted video data to the signal output control unit 17. On the other hand, the signal receiving circuit 25 retrieves an audio data from the input signal Sᵢₙ and transmits the retrieved audio data to the audio output circuit 27, for exporting the audio data to the signal output control unit 17 by the audio output circuit 27. Next, as discussed previously, the signal output control unit 17 would export the reformatted video data and audio data simultaneously to the mechanical signal selection unit 12. Based on the signal setting of the mechanical signal selection unit 12 by the user, the mechanical signal selection unit 12 would determine whether to export the reformatted video data and audio data to the HDMI connector 1a or the DVI connector 1b.

According to the above described embodiments, the instant disclosure does not require additional signal converting cables. Based on the type of the input signal, the user only needs to set the mechanical signal selection unit, to complete the transmission of the HDMI or DVI signal. Also, by using the mechanical signal selection unit 12 to determine the transmission of HDMI or DVI signal, and using the signal processing unit 19 to reformat the video data, in the instant disclosure the need for complex circuit design is eliminated, in achieving the objective of dual signal transmission capability. Thereby, the manufacturing cost of the TV digital signal receiver 1 can be further reduced.

The descriptions illustrated supra set forth simply the preferred embodiment of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A television signal receiver, comprising:
a signal processing unit for receiving and processing an HDMI or DVI signal transmitted from an electronic device;
an HDMI connector, coupled to the signal processing unit, for receiving the HDMI signal and outputting the HDMI signal from the television signal receiver, wherein the HDMI signal comprises a first audio data and a first video data;
a DVI connector, coupled to the signal processing unit, for receiving the DVI signal and outputting the DVI signal from the television signal receiver, wherein the DVI signal comprises a second video data; and
a mechanical signal selection unit, coupled to the signal processing unit on one end, and to the HDMI connector and the DVI connector on the other end, for transmitting the HDMI signal to the HDMI connector and the DVI signal to the DVI connector accordingly.

2. The television signal receiver of claim 1, wherein the mechanical signal selection unit is a manual switch.

3. The television signal receiver of claim 1, wherein the signal processing unit further comprises:
a signal retrieval module for receiving the HDMI signal or the DVI signal;
a graphics processing unit coupled to the signal retrieval module; and
a signal output control unit coupled to the graphics processing unit and the signal retrieval module, wherein when the signal received by the signal retrieval module is an HDMI signal. the signal retrieval module would retrieve the first video data and the first audio data of the HDMI signal, export the first video data to the graphics processing unit, and export the first audio data to the signal output control unit; to be compatible with a display setting of the television signal receiver, the graphics processing unit would reformat the first video data into a third video data and export the third video data to the signal output control unit, the signal output control unit would export the received third video data and the first audio data simultaneously to the mechanical signal selection unit; when the signal received by the signal retrieval module is a DVI signal, the signal retrieval module would retrieve the second video data from the DVI signal, export the second video data to the graphics processing unit; to be compatible with the display setting of the television signal receiver, the graphics processing unit would reformat the second video data into a fourth video data and export the fourth video data to the signal output control unit, the signal output control unit would export the received fourth video data to the mechanical signal selection unit.

4. The television signal receiver of claim 2, wherein the manual switch is a flip switch, a push-button switch, or a turn knob switch.
